(19) United States
(12) Patent Application Publication
(10) Pub. No.: US 2021/0132808 A1
(43) Pub. Date: May 6, 2021

(54) SYSTEM AND METHOD FOR AUTO CONFIGURATION OF APPLICATION SETTINGS USING DATA SOURCE ADMINISTRATION SCRIPTS

(71) Applicant: EMC IP Holding Company LLC, Hopkinton, MA (US)

(72) Inventors: Asif Khan, Bangalore (IN); Amith Ramachandran, Bangalore (IN); Amarendra Behera, Bangalore (IN); Deepika Nagabushanam, Bengaluru (IN); Ashish Kumar, Bangalore (IN); Pati Mohan, Bangalore (IN); Tushar Dethe, Bangalore (IN); Himanshu Arora, Bangalore (IN); Gururaj Soma, Bangalore (IN); Sapna Chauhan, Bangalore (IN); Soumen Acharya, Bangalore (IN); Reshmee Jawed, Bengaluru (IN); Shelesh Chopra, Bangalore (IN); Yasemin Ugur-Ozekinci, Oakville (CA); Arun Chakravarthy, Bengaluru (IN); Kanagasabapathy Venkatachalam, Bangalore (IN)

(21) Appl. No.: 16/672,279

(22) Filed: Nov. 1, 2019

(51) Int. Cl. G06F 3/06

(52) U.S. Cl. CPC G06F 3/065; G06F 3/067; G06F 3/0619

(57) ABSTRACT

A manager for managing generation of backups for clients includes persistent storage and a backup manager. The persistent storage stored protection policies associated with the clients and native backup functionality information associated with the clients. The backup manager programmed obtains a portion of the native backup functionality information from a client of the clients; obtains at least one protection policy of the protection policies that is associated with the client; makes a determination that the at least one protection policy and the portion of the native backup functionality information are unique; in response to the determination: generates modifier data based on: the portion of the native backup functionality information and the at least one protection policy; and generates a backup for the client using a modifier associated with the modifier data.

### BACKGROUND

Devices may generate information based on existing information. For example, devices may obtain information and derive information based on the obtained information. To obtain information, devices may be able to communicate with other devices. The communications between the devices may be through any means.

### SUMMARY

In one aspect, a manager for managing generation of backups for clients in accordance with one or more embodiments of the invention includes persistent storage and a backup manager. The persistent storage stored protection policies associated with the clients and native backup functionality information associated with the clients. The backup manager programmed obtains a portion of the native backup functionality information from a client of the clients; obtains at least one protection policy of the protection policies that is associated with the client; makes a determination that the at least one protection policy and the portion of the native backup functionality information are unique; in response to the determination: generates modifier data based on: the portion of the native backup functionality information and the at least one protection policy; and generates a backup for the client using a modifier associated with the modifier data.

In one aspect, a method for operating a manager for managing generation of backups for clients in accordance with one or more embodiments of the invention includes obtaining a portion of native backup functionality information, stored in a persistent storage, from a client of clients; obtaining at least one protection policy of protection policies that is associated with the client; making a determination that the at least one protection policy and the portion of the native backup functionality information are unique; in response to the determination: generating modifier data based on: the portion of the native backup functionality information and the at least one protection policy; and generating a backup for the client using a modifier associated with the modifier data.

In one aspect, a non-transitory computer readable medium in accordance with one or more embodiments of the invention includes computer readable program code, which when executed by a computer processor enables the computer processor to perform a method for operating a manager for managing generation of backups for clients. The method includes obtaining a portion of native backup functionality information, stored in a persistent storage, from a client of clients; obtaining at least one protection policy of protection policies that is associated with the client; making a determination that the at least one protection policy and the portion of the native backup functionality information are unique; in response to the determination: generating modifier data based on: the portion of the native backup functionality information and the at least one protection policy; and generating a backup for the client using a modifier associated with the modifier data.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a system in accordance with one or more embodiments of the invention.

FIG. 2 shows a diagram of a client in accordance with one or more embodiments of the invention.

FIG. 3 shows a diagram of protection policies in accordance with one or more embodiments of the invention.

FIG. 4A shows a flowchart of a method in accordance with one or more embodiments of the invention.

FIG. 4B shows a flowchart of a method in accordance with one or more embodiments of the invention.

FIG. 5 shows a flowchart of a method in accordance with one or more embodiments of the invention.

FIGS. 6A-6C show an example in accordance with one or more embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relates to methods and systems for providing backup services in a distributed environment. More specifically, embodiments of the invention relate to dynamically modifying the manner in which backups are generated in order to use native backup functionality.

For example, in a distributed environment, any number of entities may include functionality to generate backups. However, the entities may generate backups in different manners resulting in the scopes of protection provided by the generated backups to depend on how the backup generation functionality of the entities was invoked.

Embodiments of the invention may provide a method of orchestrating invocation of native backup generation functionality of any number of entities in a manner that results in a scope of protection provided to an entity that meets requirements of a protection policy that defines the scope of protection to be provided to the entity. To do so, embodiments of the invention may modify the manner in which native backup functionality is invoked dynamically to meet the requirements of the corresponding data protection policies. By doing so, the scope of protection provided to backed up entities may reduce the likelihood of data loss due to, for example, a hardware failure of one or more entities of the distributed system.

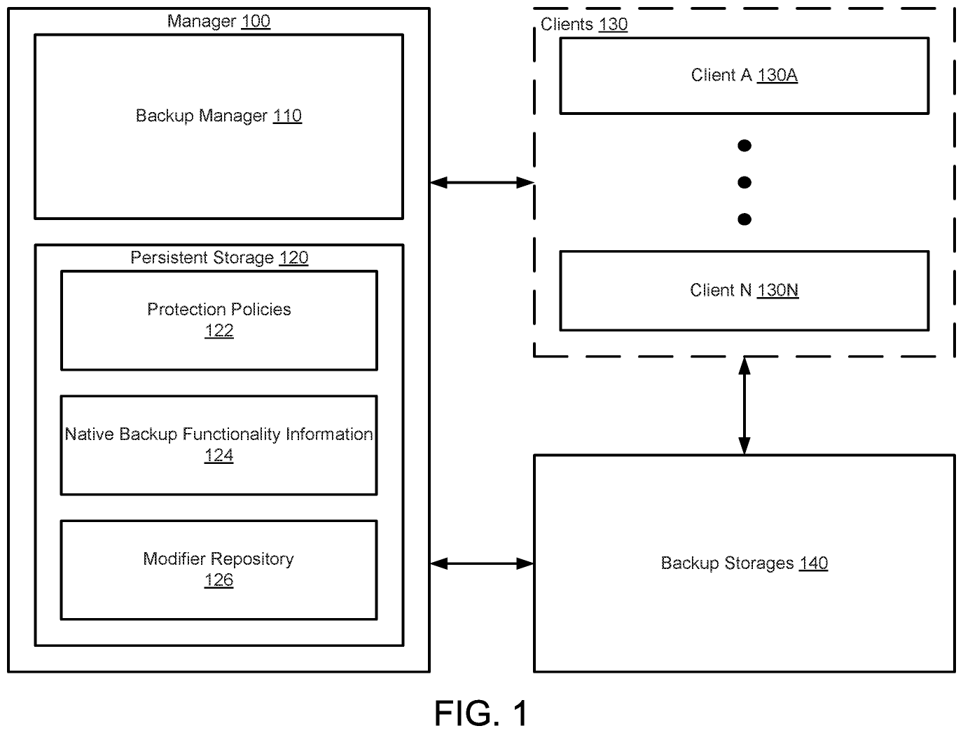

FIG. 1 shows a system in accordance with one or more embodiments of the invention. The system may include a manager (100) and clients (130). The manager (100) may provide data backup storage services to the clients (130). The data backup storage services may include storing client data in backup storages (140). The data backup storage services may further include generating modifier data which may be used to generate application specific backups of client data according to a combination of protection policies and native backup functionality information.

In one embodiment of the invention, the backup storages (140) provide data storage services to the clients (130). The data storage services may include storing of data provided by the clients (130) and providing previously stored data to the clients (130) and the manager (100). The data stored in backup storages (140) may be used for restoration purposes. The data stored in the backup storages (140) may be used for other purposes without departing from the invention.

The clients (130) may generate different types of backups. The clients (130) may generate application specific backups. The application specific backups may require modifiers that invoke unique and application specific native backup functionality to generate the application specific backups. The manager (100) may generate and send modifier data to clients (130) to generate the aforementioned application specific backups, which may then be stored in the backup storages (140).

The components of the system illustrated in FIG. 1 may be operably connected to each other and/or operably connected to other entities (not shown) via any combination of wired and/or wireless networks. Each component of the system illustrated in FIG. 1 is discussed below.

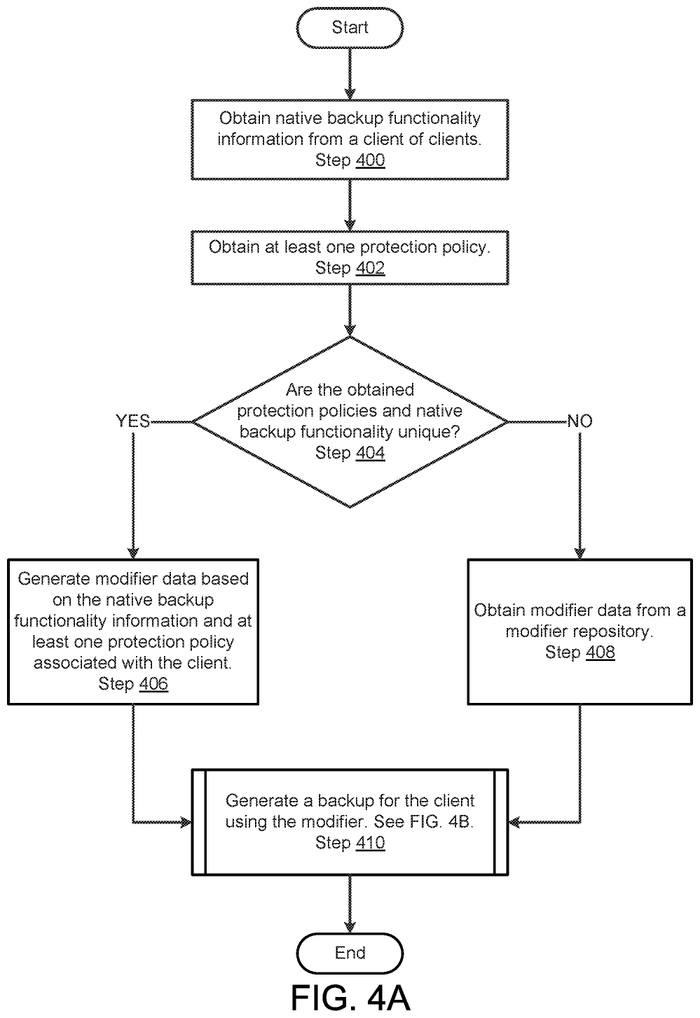

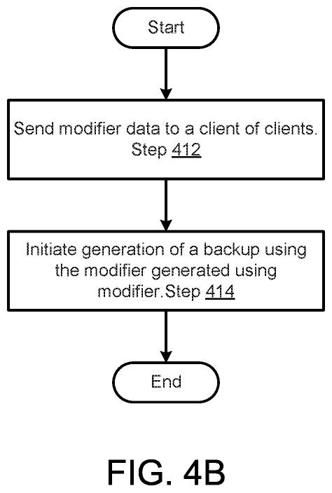

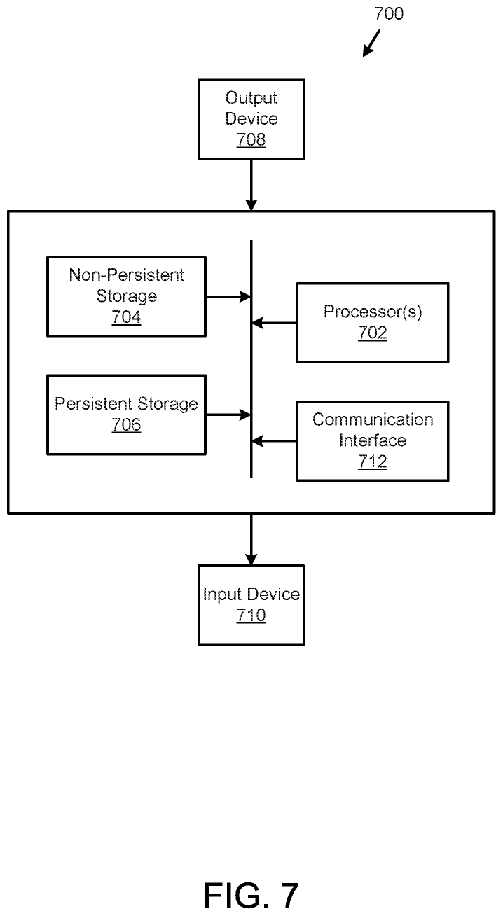

In one embodiment of the invention, the manager (100) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 4A-4B. The manager (100) may be implemented using other types of computing devices without departing from the invention. For additional details regarding computing devices, refer to FIG. 7.

The manager (100) may be implemented using logical devices without departing from the invention. For example, the manager (100) may include virtual machines that utilize computing resources of any number of physical computing devices to provide the functionality of the manager (100). The manager (100) may be implemented using other types of logical devices without departing from the invention.

As discussed above, the manager (100) may provide data backup storage services to the clients (130). The data backup storage services may include functionality for: (i) generating modifier data based on a unique combination of protection policies (122) and native backup functionality information (124), and (ii) initiating generation of a backup of client data by agents hosted by clients (130) using the generated modifier data. Further, the data backup storage services may include functionality to store generated modifier data and then subsequently obtain previously stored modifier data from a modifier repository (126) based on a non-unique combination of protection policies (122) and native backup functionality information (124). Additional detail about various embodiments of the invention related to the functionality of the manager is provided in FIGS. 4A-4B. The manager (100) may provide other and/or additional services to the clients (130) and/or other entities without departing from the invention.

The manager (100) may include a backup manager (110) and persistent storage (120). Each of these components is discussed below.

The backup manager (110) may be implemented using a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup manager (110) described throughout this application and/or all or a portion of the methods illustrated in FIGS. 4A-4B. The backup manager (110) may be another physical device without departing from the invention.

The backup manager (110) may be implemented using computer instructions (e.g., computing code) stored on a persistent storage (e.g., 120) that when executed by a processor of the manager (100) causes the manager (100) to perform the functionality of the backup manager (110) described throughout this application and/or all or a portion of the methods illustrated in FIGS. 4A-4B.

The backup manager (110) may utilize data structures stored in a persistent storage (120) of the manager (100). The persistent storage (120) may be implemented using a physical storage device. The physical storage device may include any combination of hard disk drives, solid state disk drives, tape drives, and/or any other physical storage mediums for the storage of data. The persistent storage (120) may be another type of physical storage without departing from the invention. In another embodiment of the invention, the persistent storage (120) may be implemented using a logical storage device (e.g., virtualized storage) that utilizes any quantity of hardware storage resources of any number of computing devices for storing data. For example, the persistent storage (120) may utilize portions of any combination of hard disk drives, solid state disk drives, tape drives, and/or any other physical storage medium of any number of computing devices. The persistent storage (120) may be another type of logical storage device without departing from the invention.

In one or more embodiments of the invention, the persistent storage (120) provides data storage services to clients (130), the backup manager (110), and/or other entities. The data storage services may include storing of data and providing of previous stored data. The persistent storage (120) may provide other and/or additional services without departing from the invention.

The persistent storage (120) may store data structures utilized by the backup manager (110) including protection policies (122), native backup functionality information (124), and a modifier repository (126). Each of these data structures are discussed below.

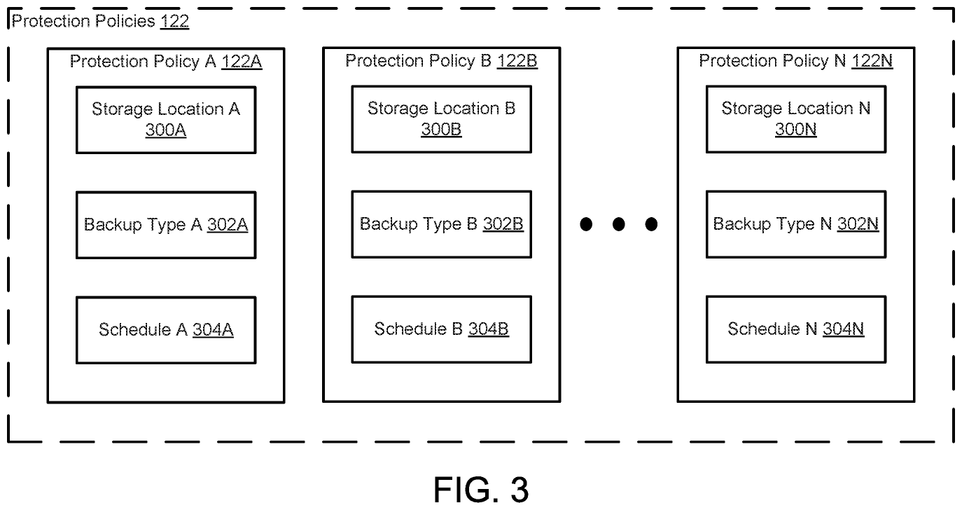

The protection policies may be data structures that include various requirements for storing backups for client applications. For example, the protection policies may include location, type, and a schedule for the backups to be generated. There may be any number of protection policies (122) stored in the persistent storage (120). The protection policies (122) may be utilized by the backup manager (110) to generate and/or select modifiers to invoke the native backup functionality of the clients. For additional information regarding protection policies (122), refer to FIG. 3.

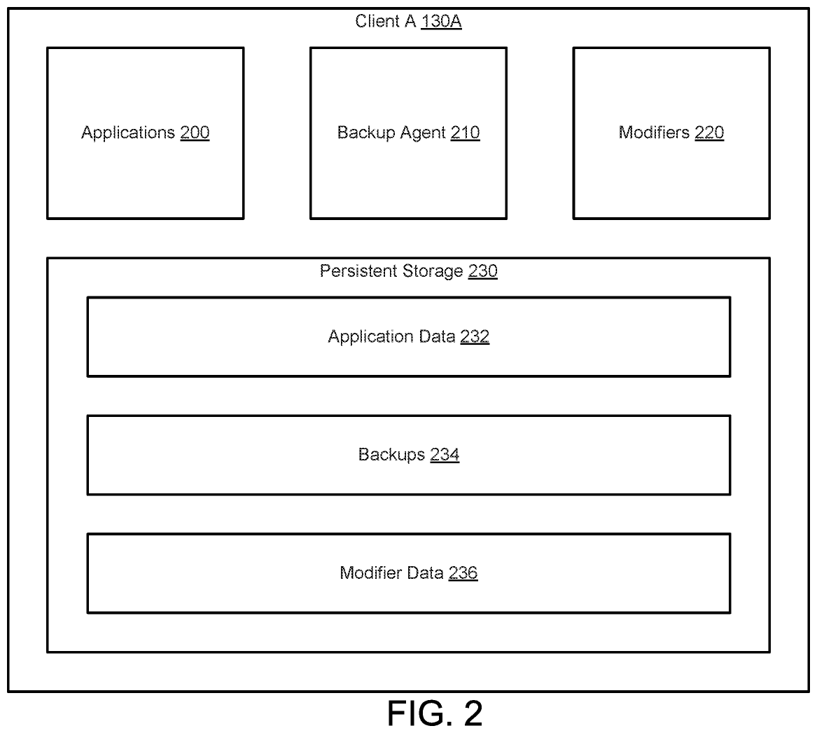

The native backup functionality information (124) may be a data structure that includes information regarding applications executing on a client (see e.g., FIG. 2, 200) and/or client (130) specific backup information. This information may include, for example, the client associated with the native backup functionality information (124), the application, application type, and other and/or additional native backup functionality information (124) without departing from the invention. The native backup functionality information (124) may be used by the backup manager (110) to generate or select modifier data which may be used to invoke the native backup functionality of applications of clients associated with the native backup functionality information (124). The native backup functionality information (124) may include other information without departing from the invention.

The modifier repository (126) may store data structures that include the previously generated modifier data (236, FIG. 2). The modifier repository (126) may also include the native backup functionality information (124) and protection policies (122) used by the backup manager (110) to generate modifier data (236, FIG. 2). There may be any quantity of modifier data (236, FIG. 2) stored in the modifier repository (126) without departing from the invention. Additional detail about modifier data (236, FIG. 2) is provided below in FIG. 2. There may also be any number of protection policies (122) and native backup functionality information (124) stored in the modifier repository (126) without departing from the invention. The modifier repository (126) may include other and/or additional information and/or data structures without departing from the invention.

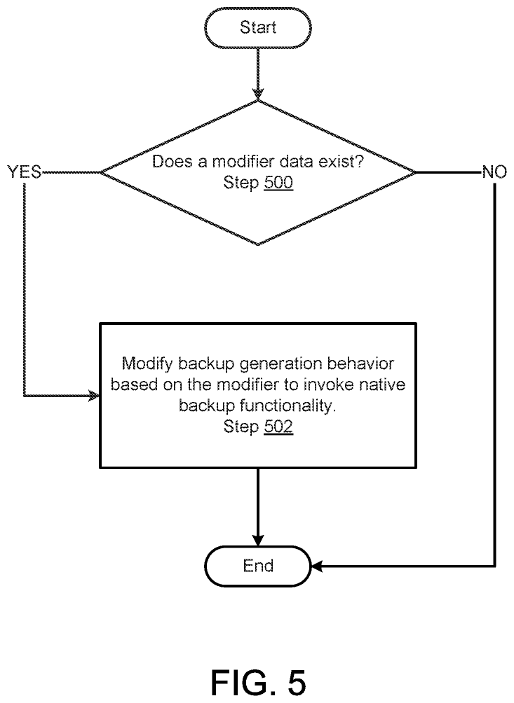

The clients (130) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 4A-5. The clients (130) may be implemented using other types of computing devices without departing from the invention. For additional details regarding computing devices, refer to FIG. 7.

The clients (130) may be implemented using logical devices without departing from the invention. For example, the clients (130) may include virtual machines that utilize computing resources of any number of physical computing devices to provide the functionality of the clients (130). The clients (130) may be implemented using other types of logical devices without departing from the invention.

The clients (130) may generate and store data. The clients (130) may utilize persistent storages (e.g., 230, FIG. 2) to store the data. The data may need extra protection to avoid data loss from persistent storage failure. The data may need extra protection for other reasons without departing from the invention. To protect the client data, the clients (130) may need to store backups of client data in backup storages (140). There may be any number of clients (e.g., 130A, 130N) without departing from the invention.

In one or more embodiments of the invention, the clients (130) may utilize data backup storage services provided by the manager (100). Using the data backup storage services may enable clients (130) to avoid data loss due to persistent storage failure or any other failures that may result in data loss by generating and storing backups in backup storages (140). The clients (130) may utilize other and/or additional services without departing from the invention.

To use the data backup storage services, the clients (130) may perform actions under the directions of the backup manager (110). By doing so, the backup manager (110) may orchestrate the transmission of data and actions between the clients (130) and the manager (100).

For example, a client (e.g., 130A) may send native backup functionality information to the backup manager (110) of the manager (100). The backup manager (110) may send modifier data (236, FIG. 2) to the client and initialize a backup of client data. The client (e.g., 130A) may the use the modifier data (236, FIG. 2) to generate a backup. The client (e.g., 130A) may store the backup in a storage of backup storages (140). For additional information regarding the clients (130), refer to FIG. 2.

In one or more embodiments of the invention, the backup storages (140) are implemented using storage devices. The storage devices may be implemented using physical storage devices and/or logical storage devices. There may be any number of storage devices in the backup storages (140). The backup storages (140) may be implemented using other types of devices that provide data storage services without departing from the invention.

A logical storage device may be an entity that utilizes the physical storage devices of one or more computing devices to provide data storage services. For example, a logical storage may be a virtualized storage that utilizes any quantity of storage resources (e.g., physical storage devices) of any number of computing devices.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

In one or more embodiments of the invention, the backup storages (140) provide data storage services to the clients (130). The data storage services may include storing data provided by clients (130) and providing of previously stored data to clients (130). Such provided data may be backups (e.g., 234 FIG. 2) used for restoration (and/or other) purposes by the clients (130). The backups stored on the backup storages (140) may be any type of backup. The backup storages (140) may provide other and/or additional services to other and/or additional entities without departing from the invention.

While the system of FIG. 1 has been described and illustrated as including a limited number of components for the sake of brevity, a system in accordance with embodiments of the invention may include additional, fewer, and/or different components than those illustrated in FIG. 1 without departing from the invention.

As discussed above, the clients (130) may generate backups and store backups in a storage of backup storages (140). FIG. 2 shows a diagram of a client (130A) of clients (130) in accordance with one or more embodiments of the invention. The client (130A) may be similar to the clients (130) shown in FIG. 1. As discussed above, the client (130A) may utilize data backup storage services from the manager (100, FIG. 1) in order to generate a backup of client data and store the backup in the backup storages (140).

The client (130A) may have components that utilize the services provided by the manager (100). These components may include applications (200), a backup agent (210), modifiers (220), and persistent storage (230). Each component of the client (130A) is discussed below.

The applications (200) may generate application data (232), which is then stored in persistent storage (230). The applications (200) may provide application services to a user of the client (130A) or other entities. The application services may be any type of computer implemented service. When a user or other entity utilizes the application services provided by the applications (200), information that is relevant to the users and/or other entities may be stored in the application data (232).

For example, an application of the applications (200) may be a database application. A user of the client (130A) may enter information into a database stored as part of the application data (232) when utilizing the services provided by the database application. By doing so, the information included in the application data (232) may be of importance to the user. Consequently, the user may desire to access the information at future points in time. However, the information may be lost if for any reason the application data (232) stored in the persistent storage (230) becomes unreachable.

To address this and other potential issues, the client (130A) may include the backup agent (210). The backup agent (210) may provide data protection services for application data (232) and/or other data hosted by the client (130A). The backup agent (210) may provide data protection services for the client (130A) under the direction of the backup manager (110, FIG. 1).

For example, the backup manager (110, FIG. 1) may initiate the data protection services of the backup agent (210). By doing so, the backup manager (110, FIG. 1) may orchestrate the generation and storage of backups in backup storages (140, FIG. 1). Consequently, data that may be used to restore the application data and/or other data of the client (130A) may be maintained in the backup storages (140, FIG. 1). In one or more embodiments of the invention, data protection services are provided by the backup agent (210) as described in FIGS. 4A-4B and in FIG. 5.

In one or more embodiments of the invention, all, or a portion, of the applications (200) and/or the backup agent (210) are hardware devices including circuitry. All, or a portion, of the applications (200) and/or the backup agent (210) may be, for example, digital signal processors, field programmable gate arrays, or application specific integrated circuits. All, or a portion, of the applications (200) and/or the backup agent (210) may be other types of hardware devices without departing from the invention.

In one or more embodiments of the invention, all, or a portion, of the applications (200) and/or the backup agent (210) are implemented using computing code stored on a persistent storage that when executed by a processor performs the respective functionalities of the applications (200) and the backup agent (210). The processor may be a hardware processor including circuitry such as, for example, a central processing unit or a microcontroller. The processor may be other types of hardware devices for processing digital information without departing from the invention.

The modifiers (220) may modify the backup generation behavior to invoke the native backup functionality of the applications (200) of the clients. Depending on the implementation of the invention, the modifiers (220) may be: (i) generated using the modifier data or (ii) the result of executing modifier data (when the modifier data is an executable). Additional detail about the modifier and modifier data is provided below. In invoking the native backup functionality, the modifiers (220) may generate application specific backups of client data and/or application data (232) based on the set of protection policies (122) and native backup functionality information (124) used to generate the modifier (220).

In one or more embodiments of the invention, the persistent storage (230) provides data storage services to the applications (200), the backup agent (210), the modifiers (220) and/or other entities. The data storage services may include storing of data and providing of previous stored data. The persistent storage (230) may be implemented using a physical storage device or a logical storage device.

A logical storage device may be an entity that utilizes the physical storage devices of one or more computing devices to provide data storage services. For example, a logical storage may be a virtualized storage that utilizes any quantity of storage resources (e.g., physical storage devices) of any number of computing devices.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

The persistent storage (230) may store data structures including the application data (232), backups (234), modifier data (236) and/or other data. Each of these structures is discussed below.

As noted above, the application data (232) may be one or more data structures that include data generated, maintained by, and/or utilized by the applications (200) of clients (e.g., 130A). The application data (232) may include any quantity and/or type of data.

The backups (234) may be data structures that include information that may be used to restore data of the client (130A). The backups (234) may include any type of backups (e.g., full backups, synthetic backups, incremental backups, etc.). The backups may be application specific backups or non-application specific backups. Application specific backups may require the modifiers (220) to modify the backup generation behavior to invoke the native application specific backup functionality in order to be generated. The backups may be non-application specific backups that do not require the modifiers (220) to modify the backup generation behavior to invoke the native application specific backup functionality to be generated. The backups (234) may include data from any number of applications (200). The backups (234) may include client data. The backups (234) may include any quantity of data without departing from the invention.

The modifier data (236) may be data structures that include information that may be used to generate modifiers (220). The modifier data (236) may be generated by the backup manager (110) and obtained by the backup agent (210). The backup agent (210) may execute the modifier data (236), and the execution of the modifier data (236) may produce the modifiers (220).

The modifier data (236) may be data structures that include sets of input variables or parameters generated by the backup manager (110, FIG. 1), stored in the persistent storage (230), and utilized by the backup agent (210). The backup manager (110, FIG. 1) may include computer instructions (e.g., computer code) that when executed by a processor generates modifiers (220). These computer instructions may require input variables generated by the backup manager (110, FIG. 1) in order to generate the modifiers (220) to invoke the native backup functionality of the certain applications (200) and generate backups according to certain set of protection policies (122, FIG. 1) and native backup functionality information (124, FIG. 1). The input variables may include native backup functionality information (124, FIG. 1) and/or protection policies (122, FIG. 1). For example, the input variables may include backup schedule, backup type, and/or storage location. The input variables may be other and/or additional variables that relate to protection policies (122, FIG. 1) and native backup functionality information (124, FIG. 1) without departing from the invention.

The modifier data (236) may be data structures that include sets of computer instructions (e.g., computer code) that are generated by the backup manager (110, FIG. 1), stored in the persistent storage (230), and utilized by the backup agent (210). The modifier data (236) may be obtained and executed by the backup agent (210) to generate modifiers (220). Each of the sets of computer instructions included in the modifier data (236) when executed by the backup agent to produce a modifier of the modifiers (220) that modifies the backup generation behavior to invoke the native application backup functionality to generate application specific backups. Each of the sets of computer instructions included in the modifier data (236) may be generated using unique combinations of protection policies (122) and native backup functionality information (124).

In another embodiment of the invention, the modifier data corresponds to an executable file(s), which becomes a modifier when executed by the client. In this scenario, the modifier is not generated by the client; rather, the modifier (which is transfer to the client as a modifier data) is directly executed by the client.

While the client (130A) of FIG. 2 has been described and illustrated as including a limited number of components for the sake of brevity, a client (130A) in accordance with embodiments of the invention may include additional, fewer, and/or different components than those illustrated in FIG. 2 without departing from the invention.

As discussed above, the backup manager (110, FIG. 1) may utilize protection policies (122) to generate modifier data (236, FIG. 2). FIG. 3 shows a diagram of protection policies (122) in accordance with one or more embodiments of the invention. The protection policies may be similar to the protections policies shown in FIG. 1. As discussed above, protection policies (122) may be data structures that include various requirements for storing backups for client applications.

There may be any number of protection policies (e.g., 122A, 122B, 122N) stored in the persistent storage (120) of the manager (100). The aforementioned requirements act as guidelines for generating backups of client data for clients (130). These guidelines may include information regarding the to-be generated backup associated with a particular protection policy. This information may include, but is not limited to, storage location (e.g., 300A, 300B, 300N), backup type (e.g., 302A, 302B, 302N), and schedule (e.g., 304A, 304B, 304N). Each of the types of information is discussed below. There may be any amount of information included in the protection policies (122) that relate to any number of different backup requirements included in the protection policies (122). There may be other and/or additional requirements included in the protection policies (122) without departing from the invention.

As discussed above, protection policies (122) may include information regarding storage locations (e.g., 300A). Storage locations (e.g., 300A) may specify the location a generated backup relate toing to a particular protection policy (e.g., 122A) will be stored in the backup storages (140, FIG. 1). For example, the storage location (e.g., 300A) may specify a storage device of the backup storages (140, FIG. 1) and a specific location in the storage device a generated backup will be stored into. Storage locations (e.g., 300A) may include other and/or additional information without departing from the invention.

Protection policies (122) may also include information regarding the type of backup (e.g., 302A) to be generated. The backup type (e.g., 302A) may specify the generated backup to be, for example, a full backup, an incremental backup, or a synthetic backup. A full backup may be a backup of some client data that includes sufficient data required to independently recover the client or client application (i.e., no other backups are required) to a predetermined point in time. An incremental backup is a backup of some client data that includes changes to the client data since a last backup of the client data was performed. The last backup prior to the increment backup could be any type of backup. A synthetic backup is a backup that is generated by merging an incremental backup with a previous full or synthetic backup. The backup type (e.g., 302A) may also specify whether a backup is an application specific backup or a non-application specific backup. The generated backup may be any type of backup without departing from the invention.

As discussed above, protection policies (122) may also include information regarding the backup schedule (e.g., 304A) for a generated backup associated with a particular protection policy (e.g., 122A). The backup schedule (e.g., 304A) may specify when a particular backup is to be generated. For example, the backup schedule (e.g., 304A) may specify the month, the day of the week, and/or the hour of the day a backup is to be generated. The backup schedule (e.g., 304A) may also specify whether a backup is to be repeated and how often the backup should be repeated. For example, a backup may be repeated hourly, daily, weekly, monthly, yearly, etc. without departing from the invention. The backup schedule (e.g., 304A) may include other and/or additional information without departing from the invention.

As discussed above, a manager in accordance with embodiments of the invention may generate modifier data adapted to invoke the native backup functionality of client applications and generate backups according to native backup functionality information from clients and all, or portions of, protection policies. FIGS. 4A-4B show methods that may be performed by the manager (100, FIG. 1) when providing the aforementioned services.

FIG. 4A shows a flowchart of a method in accordance with one or more embodiments of the invention. The method depicted in FIG. 4A may be used to provide data backup storage services to the clients. The method depicted in FIG. 4A may be performed by, for example, the manager (100, FIG. 1). Other components of the system illustrated in FIG. 1 may perform all, or a portion, of the method of FIG. 4A without departing from the invention.

While FIG. 4A is illustrated as a series of steps, any of the steps may be omitted, performed in a different order, additional steps may be included, and/or any or all of the steps may be performed in a parallel and/or partially overlapping manner without departing from the invention.

In step 400, native backup functionality information is obtained from a client of clients.

In one or more embodiments of the invention, the backup manager obtains the native backup functionality information from the backup agent of a client of clients.

For example, the backup manager may send a request for the native backup functionality information to the backup agent hosted by a client of clients. The backup agent may obtain the native backup functionality information from an application of the client and send back a message including the native backup functionality information to the backup manager. The backup agent may maintain a repository of native backup functionality information in the application data or another data structure of the persistent storage of the client. The backup manager may obtain the native backup functionality information from a client of clients via other and/or additional methods without departing from the invention.

In step 402, at least one protection policy is obtained.

In one or more embodiments of the invention, the backup manager may obtain at least one protection policy from the persistent storage of the manager. For example, the manager may maintain a repository of protection policies in a persistent storage. Each client may be associated with certain protection policies. The backup manager may obtain all, or a portion, of the protection policies associated with a client from the persistent storage of the manager. The backup manager may obtain at least one protection policy via other and/or additional method without departing from the invention.

In step 404, it is determined whether the combination of the obtained protection policies and native backup functionality information is unique.

In one or more embodiments of the invention, the backup manager uses the modifier repository to determine whether the obtained protection policies and native backup functionality information is unique. As discussed above, the modifier repository may store previously generated modifier data and associated combinations of protection policies and native backup functionality information used to generate the modifier data. The backup manager may obtain the existing sets of protection policies and native backup functionality information and compare them to the newly obtained set of protection policies and native backup functionality information.

For example, the backup manager may obtain all of the existing sets of protection policies and native backup functionality information from the modifier repository of the persistent storage individually and compare them with the newly obtained set of protection policies and native backup functionality information. The backup manager may repeat this comparison process until (i) the backup manager finds a match between an existing set of protection policies and native backup functionality information, and the newly obtained set of protection policies and native backup functionality information, or (ii) the backup manager has compared all of the existing sets of protection policies and native backup functionality information with the newly obtained set of protection policies and native backup functionality information and determines that there is no match between any of the existing sets of protection policies and native backup functionality information and the newly obtain set of protection policies and native backup functionality information.

If the backup manager finds a match between an existing set of protection policies and native backup functionality information stored in the modifier repository and the newly obtained set of protection policies and native backup functionality information, the backup manager may determine that the newly obtained set of protection policies and native backup functionality information is not unique. If the backup manager does not find a match between an existing set of protection policies and native backup functionality information stored in the modifier repository and the newly obtained set of protection policies and native backup functionality information, the backup manager may determine that the newly obtained set of protection policies and native backup functionality information is unique. The newly obtained set of protection policies and the native backup functionality information may be determined to be unique via other and/or additional methods without departing from the invention.

If it is determined the newly obtained set of protection policies and native backup functionality information is unique, the method may proceed to step 406. If it is determined the newly obtained set of protection policies and native backup functionality information is not unique, the method may proceed to step 408.

In step 406, modifier data is generated based on the native backup functionality information and at least one protection policy associated with the client.

In one or more embodiments of the invention, the backup manager generates the modifier data by generating a data structure that includes the set of protection policies and native backup functionality information. The backup manager may generate the modifier data by generating a list that includes all of the protection policies and the native backup functionality. The backup manager may generate the modifier data by generating an array that includes all of the protection policies and native backup functionality information. The backup manager may generate other types of data structures that include the set of protection policies and native backup functionality information that act as inputs to a program or script of the backup agent without departing from the invention. The modifier data may be generated via other and/or additional methods without departing from the invention.

In one or more embodiments of the invention, the backup manager generates the modifier by generating a data structure that includes a script or computer program that is adapted based on the set of protection policies and native backup functionality information.

In step 408, modifier data is obtained from a modifier repository.

In one or more embodiments of the invention, the backup manager obtains the modifier data associated with a modifier from the modifier repository of the persistent storage of the manager. As discussed above, the manager may include persistent storage that includes a modifier repository. The backup manager may store all previously generated modifier data and the sets of protection policies and native backup functionality information used to generate said modifier data. After finding a match between an existing set of protection policies and native backup functionality information and a newly obtained set of protection policies and native backup functionality information, the backup manager may then obtain the modifier data that is associated with the existing set of protection policies and native backup functionality information from the modifier repository of the persistent storage of the manager. The modifier may be obtained via other and/or additional methods without departing from the invention.

In step 410, a backup is generated for the client using the modifier. See FIG. 4B.

The method may end following step 410.

In one or more embodiments of the invention, the backup is generated via the method illustrated in FIG. 4A. Other and/or additional methods may be used to generate the backup without departing from the invention.

As discussed above, a backup may be generated using the method illustrated in FIG. 4A. FIG. 4B shows a flowchart of a method in accordance with one or more embodiments of the invention. The method depicted in FIG. 4B may be used to generate a backup for a client. The method shown in FIG. 4B may be performed by for example, the manager (100, FIG. 1). Other components of the system illustrated in FIG. 1 may perform all, or a portion, of the method of FIG. 4B without departing from the invention.

While FIG. 4B is illustrated as a series of steps, any of the steps may be omitted, performed in a different order, additional steps may be included, and/or any or all of the steps may be performed in a parallel and/or partially overlapping manner without departing from the invention.

In step 412, modifier data is sent to a client of clients.

In one or more embodiments of the invention, the backup manager sends modifier data to a backup agent of a client of clients. The backup manager may send a message including the modifier data. As discussed above, the modifier data may be a data structure that includes input variables, a data structure that includes a script adapted based on a set of protection policies and native backup functionality information, or an executable file(s). The message may include the data structures that include the modifier data. The modifier data may be sent to a client of clients via other and/or additional methods without departing from the invention.

In step 414, a backup generation using the modifier is initiated.

In one or more embodiments of the invention, the backup manager sends a message to the client requesting initiation of a backup generation. The message may request a backup agent hosted by the client to execute the modifier data to generate the modifier executing entity. The message may further request the backup agent generate a modifier using the modifier data, which is then used to invoke the native backup functionality of the applications of the client which would result in the generation of an application specific backup. The backup generation using the modifier may be initiated via other and/or additional information without departing from the invention. The backup generated in step 414 may be stored in backup storage (140).

The method may end following step 414.

As discussed above, a backup may be generated using the method illustrated in FIG. 4B. FIG. 5 shows a flowchart of a method in accordance with one or more embodiments of the invention. The method depicted in FIG. 5 may be used to generate a backup for a client in response to step 414. The method shown in FIG. 5 may be performed by for example, a backup agent (210, FIG. 2) of a client (e.g., 130A, FIG. 1). Other components of the system illustrated in FIG. 1 may perform all, or a portion, of the method of FIG. 5 without departing from the invention.

In step 500, it is determined whether modifier data exists.

In one or more embodiments of the invention, the backup agent has a flag that notifies the backup agent of newly obtained modifier data from the backup manager to be executed in order to generate a modifier to generate an application specific backup. The flag may be triggered by the backup manager after sending the modifier data to the backup agent. If the flag is triggered, the backup agent may determine that there exists modifier data to be executed to generate an application specific backup. If the flag is not triggered, the backup agent may determine that there does not exist modifier data to be executed and may proceed to not modify backup generation behavior. The backup agent may determine whether modifier data exists via other and/or additional methods without departing from the invention.

If it is determined that there exists modifier data, the method may proceed to step 502. If it is determined that there does not exist modifier data, the method may end after step 500.

In step 502, the backup generation behavior is modified based on the modifier to invoke native backup functionality.

In one or more embodiments of the invention, the backup agent modifies the backup generation behavior by executing the modifier data and producing the modifier, which generate application specific backups. The modifier invokes the native backup functionality of applications of clients to generate application specific backups. Each application of a client may have its own unique backup functionality, and therefore requires the backup agent to execute a set of modifier data to generate a modifier that modifies the backup generation behavior to invoke the unique native backup functionality of the application. The backup generation behavior may be modified via other and/or additional methods without departing from the invention.

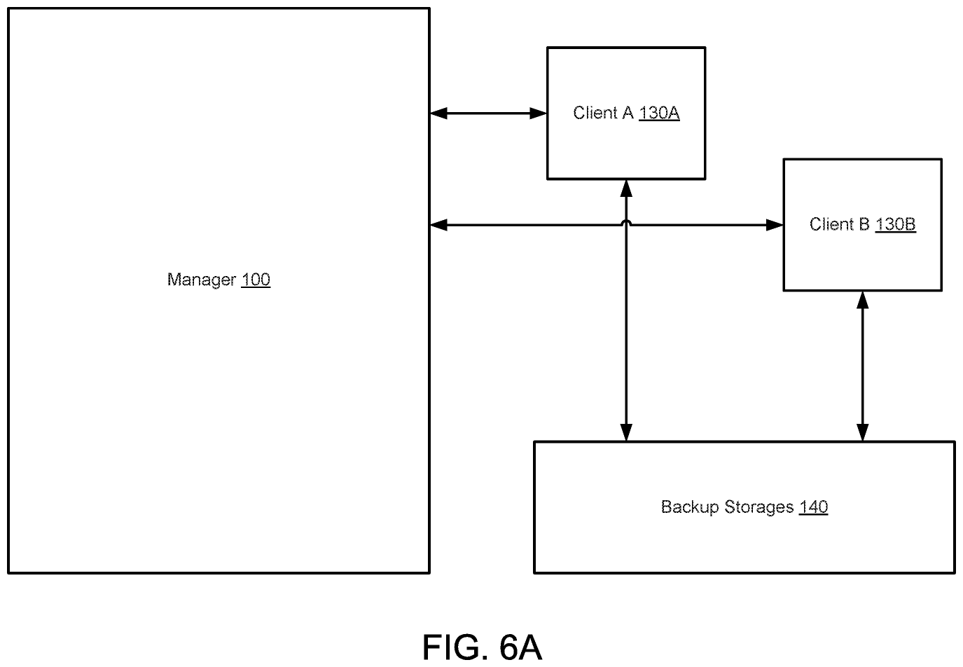

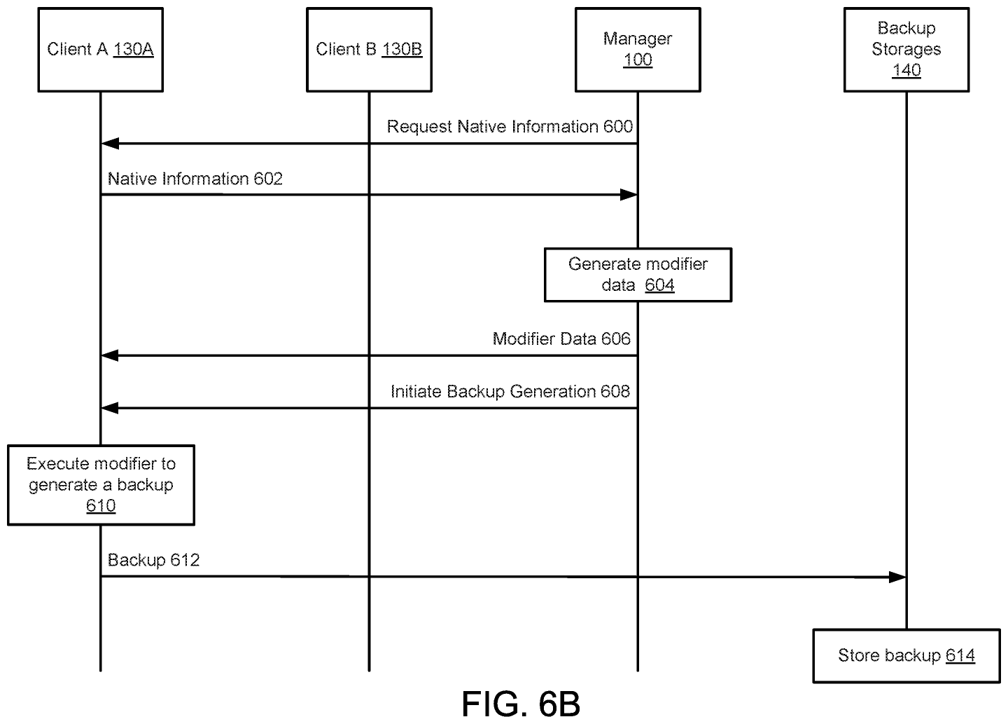

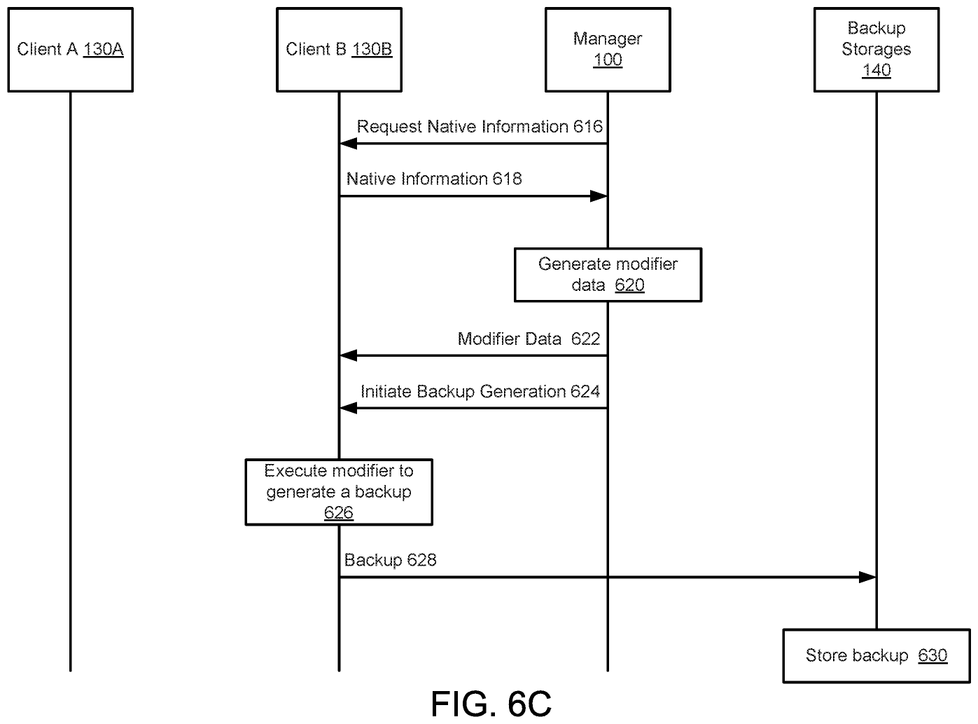

To further clarify aspects of embodiments of the invention, a non-limiting example is provided in FIGS. 6A-6C. FIG. 6A shows a diagram of an example system and FIGS. 6B-6C shows diagrams of actions that may be performed by the example system of FIG. 6A. The system of FIG. 6A may be similar to that of FIG. 1. For the sake of brevity, only a limited number of components of the system of FIG. 1 are illustrated in FIG. 6A.

### Example

Consider a scenario as illustrated in FIG. 6A in which a manager (100) is providing data backup storage services for two clients, client A (130A) and client B (130B). The manager (100) may initiate generation of backups, which are then stored in backup storages (140). As discussed above, other components of the system are not illustrated in FIG. 6A-6C for brevity.

To provide such data backup storage services, the clients (130A, 130B) (or other entities such as a backup agent of the clients) may request initiation of a backup generation. FIG. 6B shows an interaction diagram that illustrates interactions between the manager (100), client A (130A), client B (130B), and the backup storages (140).

At a first point in time, the manager (100) sends a message to client A (130A) for native information (600). In response to the request for native information (600), client A (130A) sends the native information (602) to the manager (100). After the manager (100) obtains the native information (602), the manager (100) generates modifier data (604) based on the native information and protection policies (which were previously stored on the manager).

Once the manager (100) generates the modifier data (604), the manager (100) sends the modifier data (606) to client A (130A). After the modifier data (606) is sent to client A (130A), the manager sends a message to client A (130A) to initiates a backup generation (608) on client A (130A). The manager (100) may send the message initiating the backup generation (608) to client A (130A) prior to the manager (100) sending the modifier data (606) to client A (130A) without departing from the invention. After client A (130A) obtains both the modifier data (606) and the message initiating a backup generation (608), client A (130A) executes the modifier to generate a backup (610), where the modifier is generated by processing and/or executing the modifier data. Once the backup (610) is generated, client A (130A) sends the backup (612) to the backup storages (140). After the backup storages (140) receive the backup (612) from client A (130A), the backup is stored (614) in the backup storages (140).

After generating a backup for client A (130A), client B (130B) may request backup generation initialization from the manager (100). FIG. 6C shows an interaction diagram that illustrates interactions between the manager (100), client A (130A), client B (130B), and the backup storages (140).

Referring to FIG. 6C, the manager (100) sends a message to client B (130B) that requests native information (616). In response to the request for native information (600), client B (130B) sends the native information (618) to the manager (100). After the manager (100) obtains the native information (618), the manager (100) generates modifier data (620) based on the native information and protection policies.

Once the manager (100) generates the modifier data (620), the manager (100) sends the modifier data (622) to client B (130B). After the modifier data (622) is sent to client B (130B), the manager sends a message to client B (130B) that initiates a backup generation (624) on client B (130B). The manager (100) may send the message initiating the backup generation (624) to client B (130B) prior to the manager (100) sending the modifier data (622) to client B (130B) without departing from the invention. After client B (130B) obtains both the modifier data (620) and the message initiating a backup generation (624), client B (130B) executes the modifier to generate a backup (626), where the modifier is generated by processing and/or executing the modifier data. Once the backup (626) is generated, client B (130B) sends the backup (628) to the backup storages (140). After the backup storages (140) receive the backup (628) from client B (130B), the backup (630) is stored in the backup storages (140).

End of Example

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a method for generating backups in an environment in which the native backup generation functionality of applications and/or other entities hosted by a to-be-backed up entity is invoked for backup generation purposes. Specifically, embodiments of the invention may provide a method for invoking the native backup functionality in a manner that enables protection policies that define the scope of protection to be provided to various entities of the system to be met by the generated backups. By doing so, embodiments of the invention may enable backup functionality of a myriad number of entities to be utilized while complying with protection policy requirements. By doing so, the likelihood of data of backed up entities that may otherwise be lost due to, for example, hardware failures of devices hosting the entities may be reduced.

Thus, embodiments of the invention may address the problem of the complexity of generating backups in a distributed environment in which the functionality of a multitude of entities may be invoked to generate such backups. By doing so, the cognitive burden on a user for architecting the generation and storage of backups to meet data protection policy requirements may be reduced.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A manager for managing generation of backups for clients, comprising:
persistent storage for storing:
protection policies associated with the clients, and
native backup functionality information associated with the clients; and
a backup manager programmed to:
obtain a portion of the native backup functionality information from a client of the clients;
obtain at least one protection policy of the protection policies that is associated with the client;
make a determination that the at least one protection policy and the portion of the native backup functionality information are unique;
in response to the determination:
generate modifier data based on:
the portion of the native backup functionality information, and
the at least one protection policy; and
generate a backup for the client using a modifier associated with the modifier data.

2. The manager of claim 1, wherein the persistent storage is further for storing:
a modifier repository that stores a plurality of modifier data, wherein the modifier data is one of the plurality of modifier data,
wherein each of the modifier data is associated with respective unique combinations of:
the protection policies, and
respective portions of the native backup functionality information.

3. The manager of claim 2, wherein the backup manager is further programmed to:
obtain a second portion of the native backup functionality information from a second client of the clients;
obtain at least one second protection policy of the protection policies that is associated with the second client;
make a second determination that the at least one second protection policy and the second portion of the native backup functionality information are duplicative;
in response to the second determination:
obtain a copy of previously generated modifier data based on:
the second portion of the native backup functionality information, and
the at least one second protection policy; and
generate a second backup for the second client using the copy of the previously generated modifier data.

4. The manager of claim 1, wherein generating the backup for the client using the modifier comprises:
send the modifier data to the client; and
initiate generation of the backup using the modifier.

5. The manager of claim 4, wherein the modifier is adapted to invoke native backup functionality of the client associated with the portion of the native backup functionality information.

6. The manager of claim 5, wherein invoking the native backup functionality of the client comprises invoking backup functionality of at least one entity hosted by the client.

7. The manager of claim 6, wherein the backup comprises data generated by the backup functionality of the at least one entity hosted by the client.

8. A method for operating a manager for managing generation of backups for clients, comprising:
obtaining a portion of native backup functionality information, stored in a persistent storage, from a client of clients;
obtaining at least one protection policy of protection policies that is associated with the client;
making a determination that the at least one protection policy and the portion of the native backup functionality information are unique;
in response to the determination:
generating modifier data based on:
the portion of the native backup functionality information, and
the at least one protection policy; and
generating a backup for the client using a modifier associated with the modifier data.

9. The method of claim 8, wherein the persistent storage further stores:
a modifier repository that stores a plurality of modifier data, wherein the modifier data is one of the plurality of modifier data,
wherein each of the modifier data is associated with respective unique combinations of:
the protection policies, and
respective portions of the native backup functionality information.

10. The method of claim 9, further comprising:
obtaining a second portion of the native backup functionality information from a second client of the clients;
obtaining at least one second protection policy of the protection policies that is associated with the second client;
making a second determination that the at least one second protection policy and the second portion of the native backup functionality information are duplicative;
in response to the second determination:
obtaining a copy of previously generated modifier data based on:
the second portion of the native backup functionality information, and
the at least one second protection policy; and
generating a second backup for the second client using the copy of the previously generated modifier data.

11. The method of claim 8, further comprising:
sending the modifier data to the client; and
initiating generation of the backup using the modifier.

12. The method of claim 11, wherein the modifier is adapted to invoke native backup functionality of the client associated with the portion of the native backup functionality information.

13. The method of claim 12, wherein invoking the native backup functionality of the client comprises invoking backup functionality of at least one entity hosted by the client.

14. The method of claim 13, wherein the backup comprises data generated by the backup functionality of the at least one entity hosted by the client.

15. A non-transitory computer readable medium comprising computer readable program code, which when executed by a computer processor enables the computer processor to perform a method for operating a manager for managing generation of backups for clients, the method comprises:
obtaining a portion of native backup functionality information, stored in a persistent storage, from a client of clients;
obtaining at least one protection policy of protection policies that is associated with the client;
making a determination that the at least one protection policy and the portion of the native backup functionality information are unique;
in response to the determination:
generating modifier data based on:
the portion of the native backup functionality information, and
the at least one protection policy; and
generating a backup for the client using the modifier data.

16. The non-transitory computer readable medium of claim 15, wherein the persistent storage further stores:
a modifier repository that stores a plurality of modifier data, wherein the modifier data is one of the plurality of modifier data,
wherein each of the modifier data is associated with respective unique combinations of:
the protection policies, and
respective portions of the native backup functionality information.

17. The non-transitory computer readable medium of claim 16, wherein the method further comprises:
obtaining a second portion of the native backup functionality information from a second client of the clients;
obtaining at least one second protection policy of the protection policies that is associated with the second client;
making a second determination that the at least one second protection policy and the second portion of the native backup functionality information are duplicative;
in response to the second determination:
obtaining a copy of previously generated modifier data based on:
the second portion of the native backup functionality information, and
the at least one second protection policy; and
generating a second backup for the second client using the copy of the previously generated modifier data.

18. The non-transitory computer readable medium of claim 15, wherein the method further comprises:
sending the modifier data to the client; and
initiating generation of the backup using the modifier.

19. The non-transitory computer readable medium of claim 18, wherein the modifier is adapted to invoke native backup functionality of the client associated with the portion of the native backup functionality information.

20. The non-transitory computer readable medium of claim 19, wherein invoking the native backup functionality of the client comprises invoking backup functionality of at least one entity hosted by the client.
